(19) United States
(12) Patent Application Publication
(10) Pub. No.: US 2012/0255375 A1
(43) Pub. Date: Oct. 11, 2012

(54) APPARATUSES AND METHODS FOR CAPTURING AND RETAINING PARTICLES

(75) Inventors: Kui-Chiu Kwok, Eden Prairie, MN (US); Al Vatine, Eden Prairie, MN (US)

(73) Assignee: LMS Technologies, Inc., Bloomington, MN (US)

(21) Appl. No.: 13/422,385

(22) Filed: Mar. 16, 2012

Related U.S. Application Data
(60) Provisional application No. 61/474,245, filed on Apr. 11, 2011.

(51) Int. Cl. G01N 1/22

(52) U.S. Cl. 73/863.22

(57) ABSTRACT

Various embodiments comprise apparatuses and methods for capturing particles from a particle-laden airstream. An embodiment of a device includes an inlet air passage to direct a particle-laden airstream, an outlet air passage, an impaction nozzle in fluid communication with and downstream of the inlet air passage, and a channel in fluid communication with and downstream of the impaction nozzle and upstream of the outlet air passage. An open portion of the channel is oriented substantially toward the inlet air passage and has a cavity at least partially covered with a substrate material. A base of the substrate material is substantially normal to an incoming direction of the particle-laden airstream. Other embodiments of the device and a method of using the device are also provided.

### RELATED APPLICATION

This application claims priority benefit to U.S. Provisional Patent Application Ser. No. 61/474,245 entitled, “DEVICE AND SUBSTRATE FOR CAPTURING AND RETAINING PARTICULATES,” filed Apr. 11, 2011, which is hereby incorporated by reference in its entirety.

### BACKGROUND

Many filtration methods and devices have been devised to remove particles from air. The devices may be used to, for example, remove particles from the air to increase cleanliness of the air (e.g., for use in surgical environments and semiconductor fabrication facilities), retain particles for chemical analysis (e.g., by energy dispersive x-ray spectroscopy), or to determine a range of particle sizes or conduct other analyses of particles in an air stream.

One of the devices to remove particles is an inertial impactor. With reference to FIG. 1, a cross-sectional view of an inertial impactor 100 is shown to include an inlet 101 for a particle-laden airstream, an impaction nozzle 103, and an impaction plate 105. The inertial impactor may be characterized by a length, T, of the impaction nozzle 103, the interior width or diameter, W, of the impaction nozzle 103, and a distance, H₁, from the impaction nozzle 103 to the impaction plate 105.

As particle-laden air enters the inlet 101, a number of streamlines 109 of air carry a variety of particle sizes including larger particles 111A and smaller particles 111B. The streamlines may either be forced through the impaction nozzle 103 by, for example, a vacuum of other pumping mechanism (not shown) that form a pressure-gradient across the inertial impactor 100.

In operation, the particle-laden air is accelerated towards the inertial impactor 100 by the pressure gradient. Particles and air are travelling toward the inertial impactor 100 at approximately the same velocity. As the particles and air enter into the impaction nozzle 103, they are accelerated to a higher velocity due to a reduction of area from the inlet 101 compared with the interior width, W, of the impaction nozzle 103. The particles readjust their velocities quickly, substantially matching the velocity of the air. Then, due to the increased inertia and mass of the larger particles 111A, they are impinged onto the impaction plate 105. Thus, particles larger than a certain size, such as the larger particles 111A, will be impinged and possibly retained by the impaction plate 105 while the smaller particles 111B will follow the streamlines 109 out of the inertial impactor 100. The smallest particle size that is impinged is referred to as the particle cutoff-diameter, discussed in more detail with reference to FIG. 2, below.

A determination of what particle sizes may be impacted and what particle sizes will follow the streamlines may be determined theoretically by equation (1), known as the Stokes Equation;

$${D}_{p} = \sqrt{\frac{9 ( {μ}_{air} ) ( W ) ( Stk )}{( {ρ}_{p} ) ( {v}_{o} ) ( {C}_{c} )}} \qquad ( 1 )$$

where Dₚ is the particle cutoff-diameter, μₐᵢᵣ is the viscosity of air, W is the nozzle width or diameter, Stk is the Stokes number (the ratio of the stopping distance of a particle to some characteristic dimension of the obstacle such as H₁), and C_{c} is the Cunningham slip correction factor (to account for non-continuum effects when calculating the drag force on small particles).

Referring now to FIG. 2, a graph 200 of collection efficiency as a function of particle size (where particle size is directly related to the square root of the Stokes number, \sqrt{Stk}) for the inertial impactor of FIG. 1 is shown. In the graph, a vertical line indicates an ideal cutoff-diameter 201 for the theoretical cutoff for particles; particles smaller (e.g., such as the smaller particles 111B of FIG. 1) than the ideal cutoff-diameter 201 make it through the inertial impactor 100 and particles larger (e.g., such as the larger particles 111A of FIG. 1) than the ideal cutoff-diameter 201 are impacted onto the impaction plate 105.

An actual cutoff curve 205 indicates practical performance of the inertial impactor with some portion of oversize particles 207 that make it through the impactor and some portion of undersized particles 209 that are impacted onto the impaction plate 105. A 50% collection efficiency line 203 indicates a size of particles that have a 50% probability of making through the inertial impactor 100 and a 50% probability of being impacted onto the impaction plate 105.

With reference again to FIG. 1, the inertial impactor 100 of FIG. 1 has associated problems. The Stokes equation indicates that the higher the particle velocity as it is accelerated through the impaction nozzle 103 toward the impaction plate 105, the smaller the particle cutoff-diameter. However, a high particle velocity also causes the particle to bounce upon impacting on the impaction plate 105.

For example, solid particles frequently bounce off the impaction plate 105 and may become re-entrained and follow the streamlines 109 out of the inertial impactor 100. Liquid particles may break up into smaller particles due to high impaction energy. The resultant smaller liquid particles may then also follow the streamlines 109 out of the inertial impactor 100. In order to mitigate the bounce problem of solid particles, the impaction plate 105 may be coated with a thin layer of grease or impregnated with oil. However, these methods can fail after a layer of solid particles have deposited onto the impaction plate 105, causing subsequent incoming particles to bounce from the impaction plate 105, or from particles already impacted on the impaction plate 105. Thus, the holding capacity of retained and captured particles from the impaction plate 105 can be very low. Other attempts to increase the percentage of retained particles can result in an increased pressure drop through the inertial impactor 100, leading to increased energy usage.

### BRIEF DESCRIPTION OF THE DRAWINGS

FIG. 1 shows a cross-sectional view of an inertial impactor;

FIG. 2 shows a graph of collection efficiency as a function of particle size for the inertial impactor of FIG. 1;

FIG. 3A shows an illustrative cross-sectional drawing of an embodiment of a particle-impaction device for capturing and retaining particles in accordance with various embodiments described herein;

FIG. 3B shows an illustrative three-dimensional drawing of a specific embodiment of a particle-impaction device for capturing and retaining particles in accordance with various embodiments described herein;

FIGS. 4A through 4D show various types of substrates that may be used with the particle-impaction devices of FIG. 3A and FIG. 3B;

FIGS. 5A through 5F show various types of channel and substrate combinations for capturing and retaining particles;

FIG. 6A shows an illustrative embodiment of a multi-stage inertial impactor utilizing multiple stages of the particle-impaction devices of FIG. 3A and FIG. 3B;

FIG. 6B shows illustrative example details of an air/liquid separator coupled to the multi-stage inertial impactor of FIG. 6A; and

FIGS. 7A and 7B are graphs of particle fractional efficiency as a function of particle diameter for various ones of the devices, substrates, apparatuses, and combinations thereof as discussed with reference to FIG. 3A through FIG. 6B.

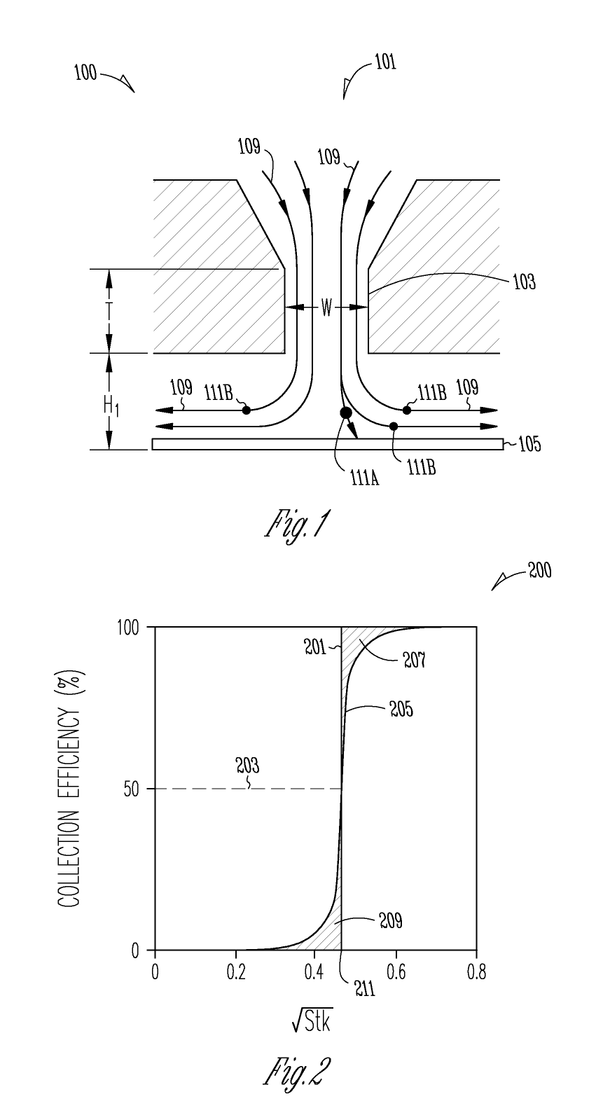

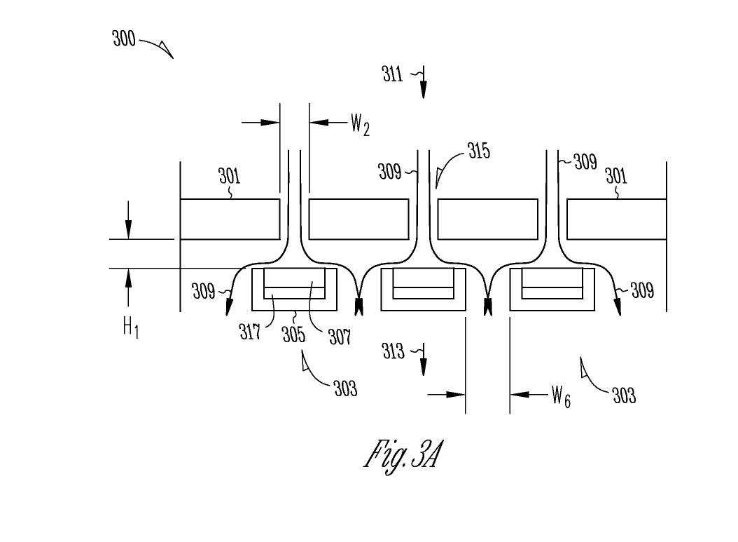

### DETAILED DESCRIPTION

Atmospheric or human-generated particles can be solid or liquid. Certain types and concentrations of particles can be hazardous to human health. Thus, particles frequently need to be removed in many industrial applications. For example, air filtration for engines, clean rooms in semiconductor fabrication facilities, hospitals, surgical rooms, office buildings, and so on need to have particles removed to function properly or more efficiently. The particle range of general interest for these various applications may extend from less than about 0.1 microns (μm) up to 1 mm or greater.

Minimizing energy consumption is an important and major factor for all filtration applications and devices. Typical filtration methods and devices use a media with certain pore sizes to intercept particles while allowing air to pass through. All filters or filtration methods are rated by three performance parameters: collection efficiency, pressure drop, and particle holding capacity. Collection efficiency is a function of particle size and is referred to as fractional efficiency.

Based on testing standards established by the American Society of Heating, Refrigerating, and Air-Conditioning Engineers (ASHRAE), a filter may be rated by using a range of challenge particle sizes from 0.3 μm to 10 μm. A high-efficiency filter (e.g., a high-efficiency particulate air (HEPA) filter) will have a minimum particle efficiency of 99.997% of particle collection efficiency at 0.3 μm at a given face velocity (the velocity of the incoming airstream normal to the filter). To reduce energy consumption, the filtration industry desires a filter with high fractional efficiency and holding (e.g., retention or loading) capacity at the lowest possible pressure drop. The holding capacity determines the service life and hence the cost of filter usage over time.

As discussed herein, various embodiments of the subject matter relate generally to the capturing and retaining of particles using impaction, interception, and diffusion mechanisms. The first two mechanisms, interception and impaction, are important for particles larger than about 1 μm. For particles less than 1 μm, diffusion becomes increasingly more important.

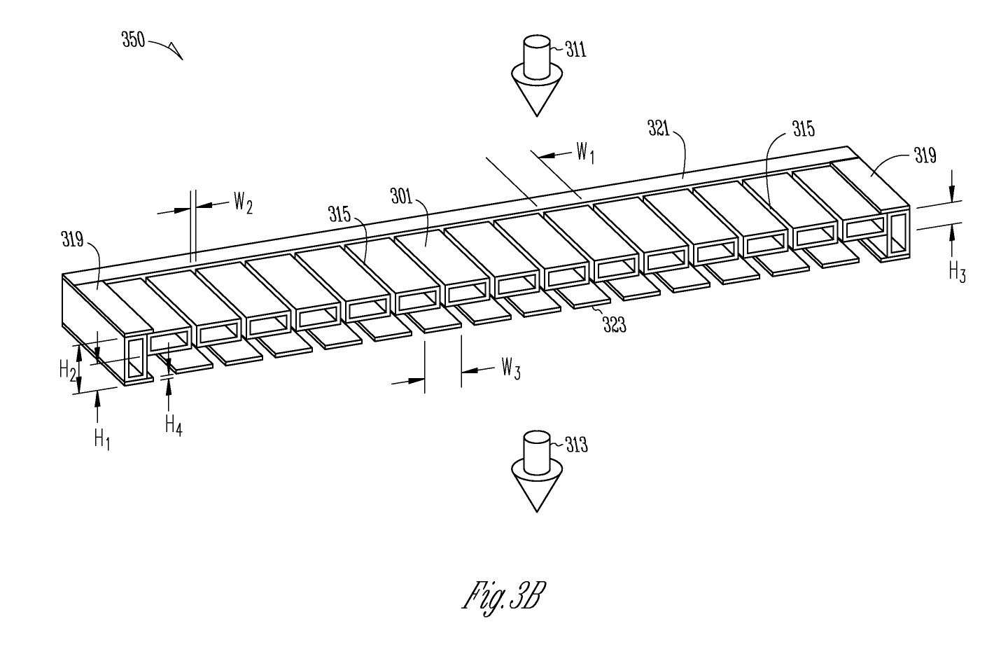

With reference now to FIG. 3A, an illustrative cross-sectional drawing of an embodiment of a particle-impaction device 300 for capturing and retaining particles is shown. The device is configured to perform a filtration function and includes a number of nozzle plates 301 are spaced-apart laterally from one another. Each pair of the nozzle plates 301 forms an impaction nozzle 315 that directs particle-laden air from an inlet 311 through a number of streamlines 309 towards a number of impaction plates 303. Since a cross-sectional area of the opening of the impaction nozzle 315 is smaller than the cross-sectional area of the opening of the inlet 311, the streamlines 309 (formed by the particle-laden air) are increased in velocity as they pass through the impaction nozzle 315. The streamlines 309 then exit the particle-impaction device 300 toward an outlet 313. The impaction plates 303 may be formed at a distance, W₆, apart from one another. The impaction plates 303 are discussed in more detail, below.

Although the particle-impaction device 300 of FIG. 3A indicates a number of the impaction nozzles 315 and a number of the impaction plates 303, the particle-impaction device 300 may also be formed with a single one of the impaction nozzles 315 and a single one of the impaction plates 303. A cross-sectional area (as viewed from above) of the shape of the impaction nozzles may be round, elliptical, square, rectangular, or other polygonal or irregular shapes. Various forms of the Stokes equation (equation (1)), discussed above, take the various geometries into account.

Each of the impaction nozzles 315 has a width, W₂. The width may be determined based on a number of parameters discussed above with reference to the Stokes equation. Although FIG. 3A indicates that each of the impaction nozzles 315 has the same or similar width, the device may be fabricated to have a number of various widths. A person of ordinary skill in the art will recognize, upon reading and understanding the disclosure provided herein, that if a number of different widths are chosen for the impaction nozzles 315, then some pressure balancing means may be useful to prevent the streamlines from only entering the larger ones of the impaction nozzles 315. One means to balance the pressure may involve placing the impaction plates at different distances from respective ones of the nozzle plates 301.

In a specific embodiment, each of the nozzle plates 301 is placed at a pre-determined distance, H₁, above the number of impaction plates 303. This distance may be referred to as the “nozzle-to-plate” distance. The nozzle-to-plate distance, H₁, may be similar to the width, W₂, of the impaction nozzles. If the nozzle-to-plate distance is too small, the pressure drop across the particle-impaction device 300 increases. However, if the nozzle-to-plate distance is too large, the velocity of the particles decreases and the particle cutoff-diameter, as determined by the Stokes equation, also decreases. A hydrodynamic boundary layer formed above the impaction plates 303 also increases as the velocity increases making it more likely for larger particles to remain flowing with the streamlines 309.

To eliminate the problem of particle bounce as found in inertial impactors of the prior art, the impaction plates 303 will benefit from being able to absorb the kinetic energy of the impinged particles by reducing the particle velocity through various types of substrate material discussed herein. The various types of substrate material allow the particles to experience a velocity gradient rather than coming to a sudden stop as found in the prior art. The impaction plates 303 provided herein can reduce or eliminate bounce and can be designed to have a high particle-holding capacity, coupled with a low pressure drop across the particle-impaction device 300.

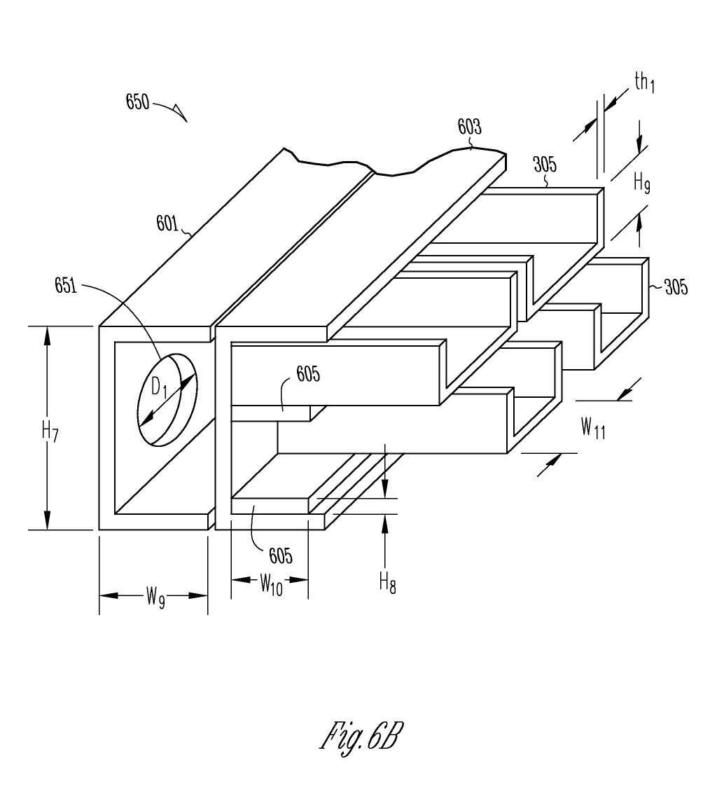

With continuing reference to FIG. 3A, the impaction plates 303 are shown to be comprised of a channel 305, a substrate material 307, and a cavity 317 formed between the substrate material 307 and a bottom portion of the channel 305. An open portion of the channel 305 and the substrate material 307 are substantially aligned with the inlet providing a fluid (e.g., air) passage through the impaction nozzle 315 for the particle-laden airstream. In various embodiments, the cavity 317 may be an air-space. In FIG. 3A, the channel 305 has sides elevated above a base (as viewed from the end as in FIG. 3A) but may take on a number of forms and geometries other than as shown in FIG. 3A. For example, the channel 305 may have a rounded bottom or other trough-like shape. In other embodiments, the substrate material 307 may be in substantial contact with the bottom portion of the channel, as discussed with reference to FIG. 3B, below. Thus, in this embodiment, the cavity is reduced in size or is non-existant. However, in applications where the streamlines 309 have a substantial amount of liquid (e.g., water) contained therein, there may be advantages in having a channel-shaped or trough-like structure similar to that shown. This embodiment for removing liquid from the channels 305 is discussed with reference to FIG. 6B, below.

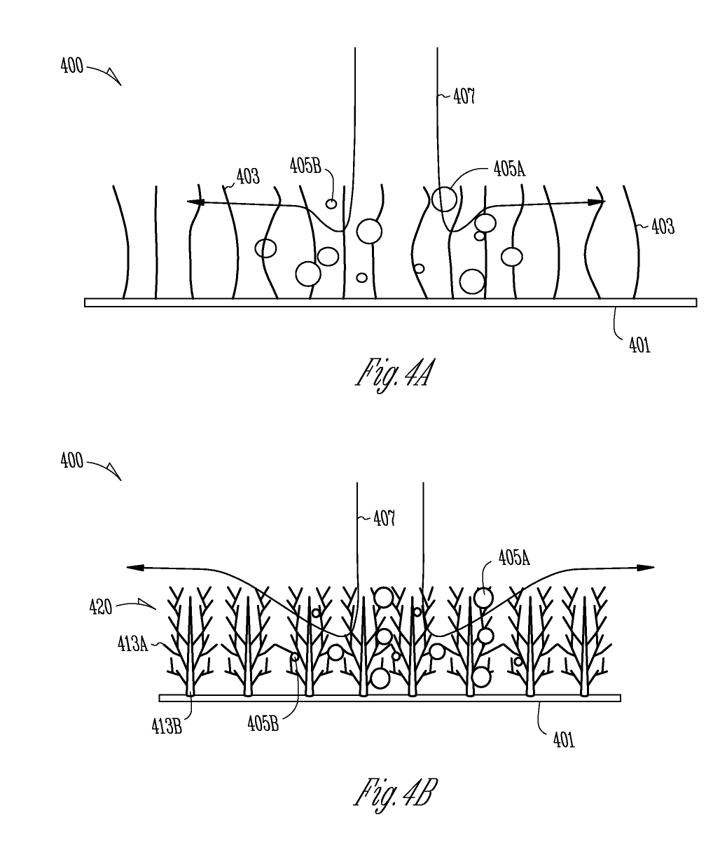

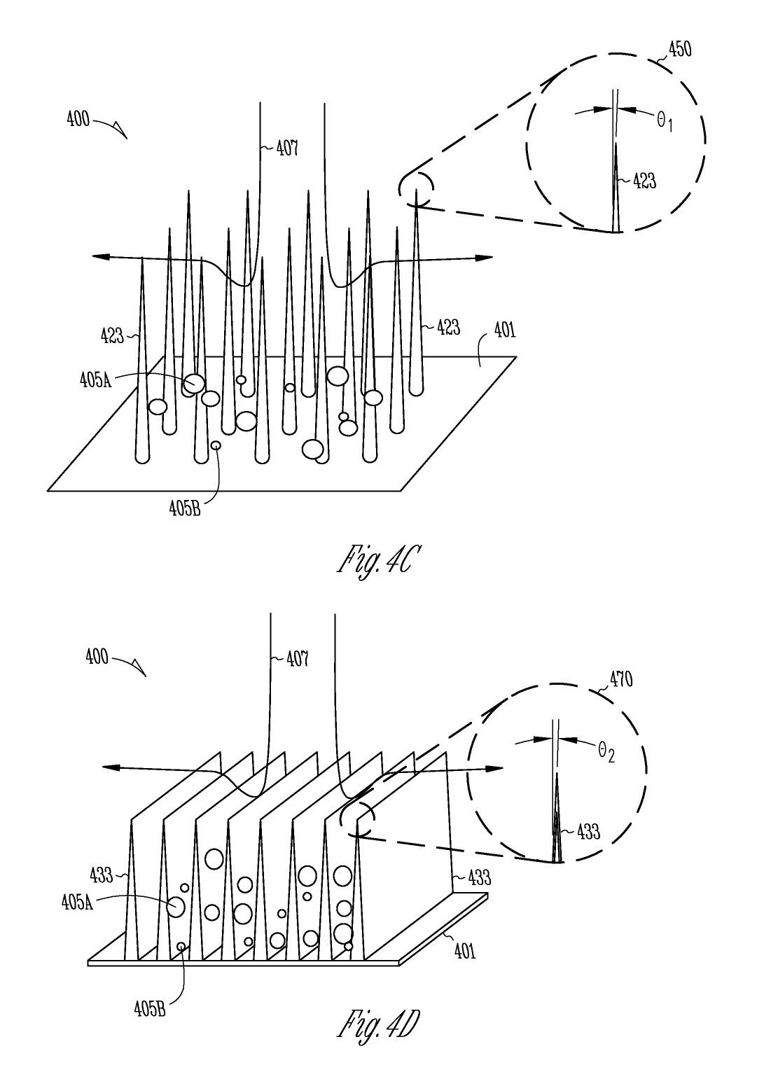

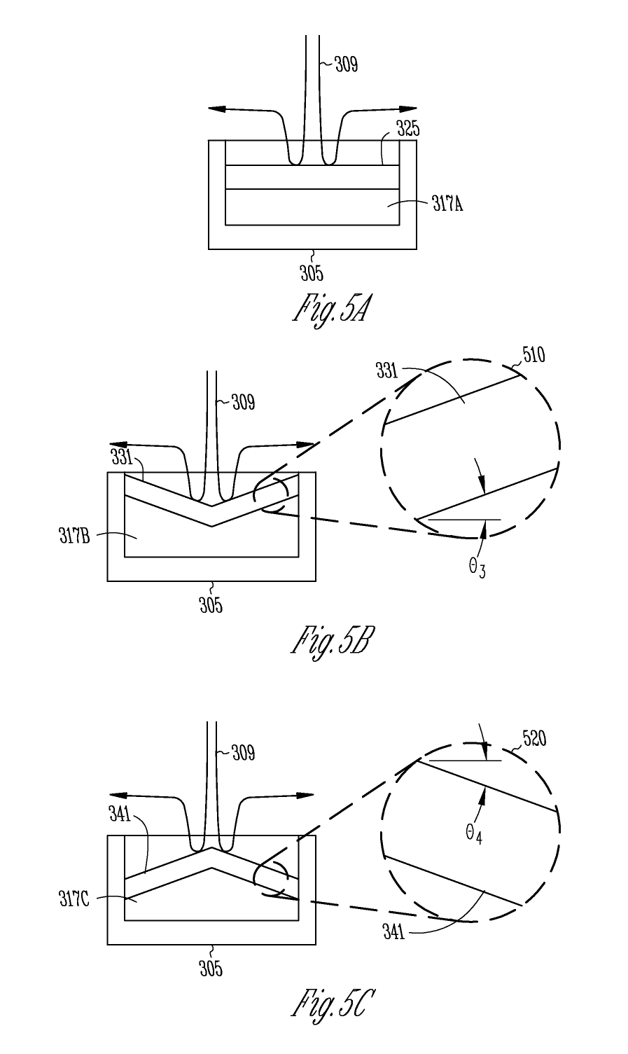

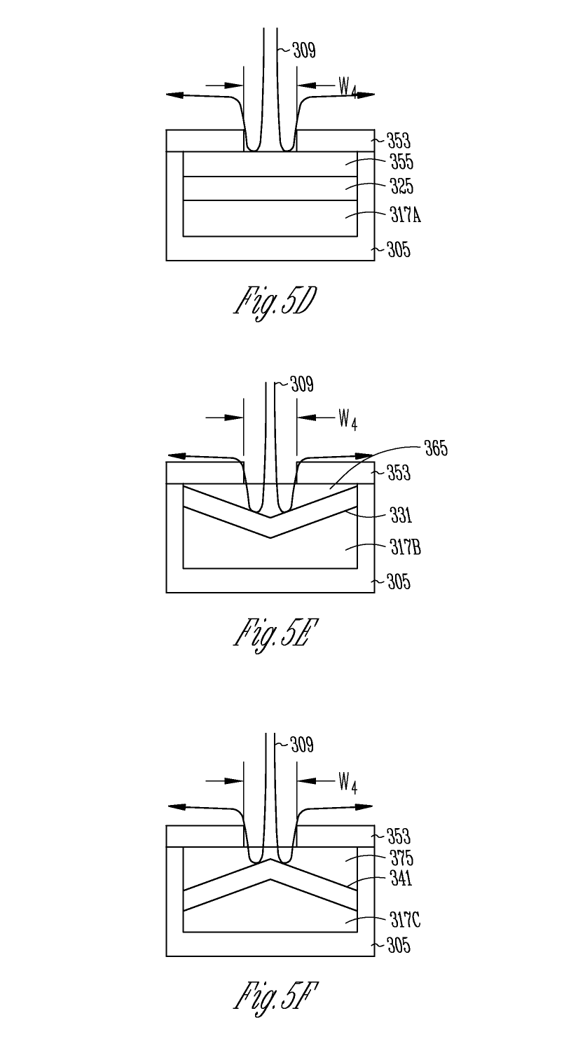

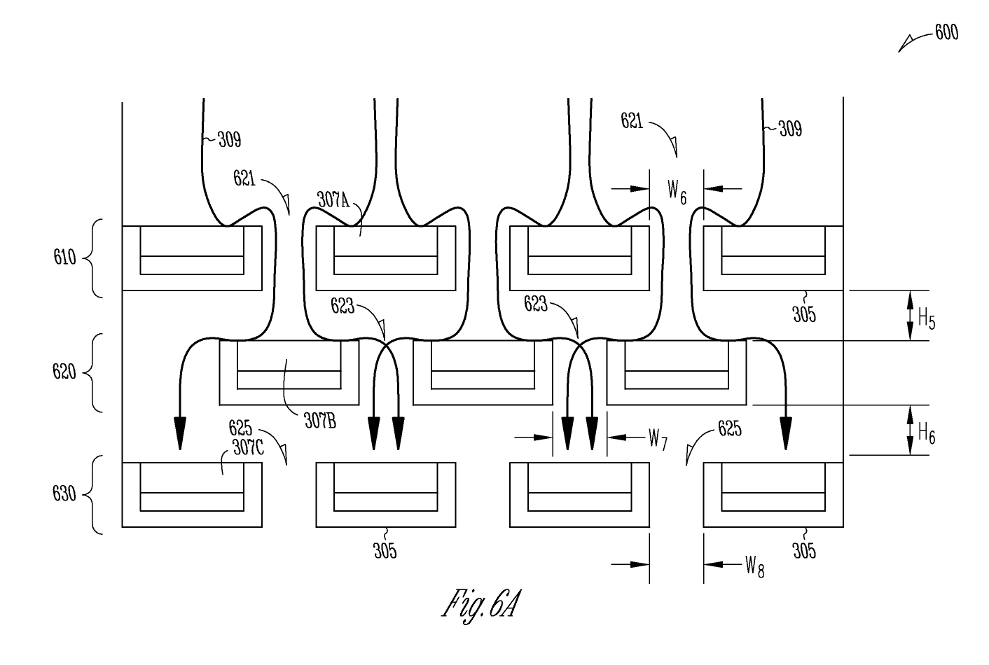

Additionally, various embodiments of the substrate material 307 are discussed with reference to FIG. 4A through FIG. 4D, below. Further, various geometries of the impaction plates 303 are discussed with reference to FIG. 5A through FIG. 5F, below.

Generally, the substrate material 307 may be comprised of any number of porous or semi-porous materials. The porous and semi-porous materials may be, in some embodiments, woven or non-woven materials. The porous and semi-porous materials may include, for example, cloth, felt, velvet, mesh, metal screen, foam, ceramic, porous and semiconductor-porous plastic, a compilation of various fiber types, and so on. Porous and semi-porous materials can be a material having open or partially open pores or cells such that a fraction of the volume of the material is open space. Open cells may be interconnected in such a manner that collected particles can pass from one cell to another. More specifically, cloth may be considered to be a material produced by weaving, felting, knitting, or bonding natural or synthetic fibers or filaments. Felt may be considered as a porous or semi-porous fibrous structure. The structure may be unwoven and created by interlocking fibers using heat, moisture, or pressure. The fibers can include, for example, polyester, polyurethane, polypropylene, and other synthetic and natural fibers. Foam can be either a flexible or rigid material in which the apparent density of the material is decreased substantially by the presence of numerous cells or gas pockets disposed throughout the volume of the foam. Foam can be comprised of substrates including, for example, polymers, vitreous carbon, metals, ceramics, and other materials.

Referring now to FIG. 3B, an illustrative three-dimensional drawing of a specific embodiment of a particle-impaction device 350 for capturing and retaining particles is shown. The particle-impaction device 350 is similar to the particle-impaction device 300 of FIG. 3A but may include a number of flat impaction-plates 323 rather than the impaction plates 303 of FIG. 3A having channels 305. In other embodiments, the impaction plates 303 may be used instead of or in combination with the flat impaction-plates 323. Unlike the impaction plates 303, the flat impaction-plates 323 do not have a cavity.

As shown, the nozzle plates 301 are formed from a tubular material. However, the tubular material is unimportant to the function of the particle-impaction device 350 and may be considered to, for example, reduce material costs and weight. The flat impaction-plates 323 may be covered on an upper-surface (i.e., between the flat impaction-plates 323 and the nozzle plates 301) with velvet, mesh, or one or more other porous or semi-porous materials. These materials may be attached to the flat impaction-plates 323 with, for example, a chemical adhesive including tape, glue, and other binding material.

In a specific embodiment of the particle-impaction device 350, the flat impaction-plates 323 have a width, W₃, of approximately 31.75 mm (1.25 inches) and a height, H₄, of 3.175 mm (0.125 inches). A distance, H₁, between the nozzle plates 301 and the flat impaction-plates 323 is approximately 15.9 mm (0.625 inches), although attaching materials such as velvet to the flat impaction-plates reduces the distance H₁. A height, H₃, of the nozzle plates 301 is approximately 19.1 mm (0.75 inches), with an overall height, H₂, from the top of the nozzle plates 301 to the bottom of the flat impaction-plates 323, of approximately 38.1 mm (1.5 inches). The particle-impaction device 350 is designed to have a particle cutoff-diameter of 3.12 μm, based on a volumetric flow-rate of approximately 56.6 cubic meters-per-minute (2000 cubic feet-per-minute (cfm)) of air and a pressure drop across the particle-impaction device 350 of approximately 565 Pa (2.27 inches of water column). The width, W₂, of each of the 14 impaction nozzles 315 is approximately 3.63 mm (0.143 inches).

The impaction nozzles 315, the nozzle plates 301, and the flat impaction-plates 323 are supported by structural side channels 319 and a structural backplane 321. Each of these may be formed from, for example, aluminum or other non-ferrous metal, plastic, ceramic, or one or more of a number of other materials.

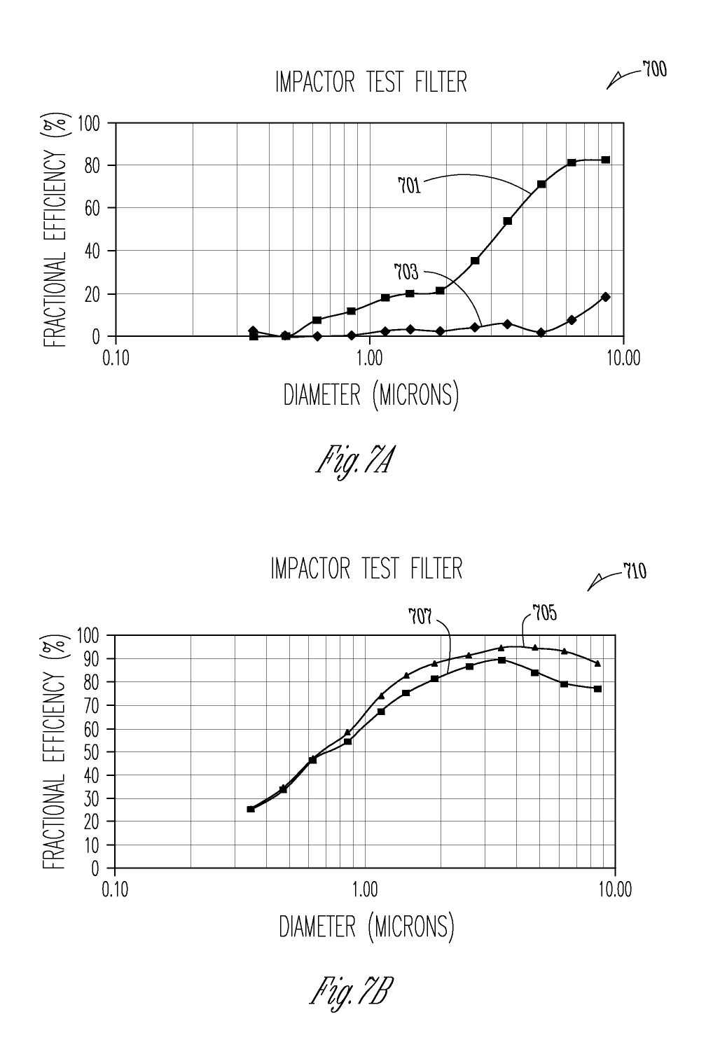

With reference now to FIGS. 4A through 4D, various types of substrates 400 are shown that may be used with the particle-impaction devices of FIG. 3A and FIG. 3B. For example, any of the substrates 400 may be used for the substrate material 307 in FIG. 3A. One example of a carpet-like material that may be used in the substrate 400 is velvet. As discussed with reference to FIG. 7A and FIG. 7B, below, the substrate 400 with velvet has a high collection-efficiency as compared with, for example, a bare aluminum impaction plate. Each of the substrates 400 may be cleaned by various methods and means known independently in the art. Further, each of the substrate 400 may comprise materials that are either hydrophilic or hydrophobic.

With specific reference to FIG. 4A, the design of the substrate 400 includes a number of fibers 403 mounted to a base 401. The fibers 403 may have carpet-like or finger-like structures standing substantially vertically-oriented relative to the incoming particles and air in the streamlines 407. Such vertically-oriented ones of the fibers 403 in the design configuration of the substrate 400 allow air and particles to penetrate into the substrate 400. Particles are intercepted and captured by the fibers 403 while air can escape between the fibers 403.

Due to a larger inertial force, larger particles 405A may penetrate more deeply into the substrate 400 than smaller particles 405B. The substrate 400 reduces or eliminates bouncing of particles because there is little or no air turbulence inside the space formed by the fibers 403. Thus, the particles cannot be readily re-entrained into the streamlines 407 and carried out of the substrate 400.

There are at least four design parameters that may be considered in constructing the substrate 400. The parameters include (1) fiber size or diameter; (2) spacing formed between the fibers; (3) the length of fibers, and (4) softness and porosity of the base material holding the fibers. In general, the first three parameters should be a similar order of magnitude as the range of particles sizes that are desired to be captured.

For example, if the largest particle size desired to be captured is 10 μm, the fiber diameter may be chosen to not be larger than approximately ten-times the particle size. That is, for this example, the fiber diameter may be chosen to be less than 100 μm to capture particles 10 μm and smaller. The spacing formed between the fibers may be chosen to not be larger than approximately 1,000 times the biggest particle diameter desired to be captured. The length of the fibers may be chosen to not be less than approximately five-times the spacing distance.

The base 401 of the substrate 400 can be made of soft material, such as cloth. The softness of the substrate 400 further absorbs the kinetic energy of particles to reduce particle bounce and re-entrainment. The relatively large spacing formed between the fibers 403 provides a large holding capacity for captured particles.

In FIG. 4B, a tree-like structure 420 is used to form the substrate 400. The process, mechanisms, and design principles for capturing particles without bounce is similar to that of the fiber 403 structure discussed with reference to FIG. 4A. The tree-like structure 420 also has a high particle holding capacity.

In the tree-like structure 420, a number of small fibers 413A extend out from a larger fiber stem 413B in a branch-like manner. The branches, comprised of the number of small fibers 413A, can capture and retain the smaller particles 405B. The tree-like structure 420 may be manufactured by, for example, a bundle of submicron-sized fibers twisted as the larger fiber stem 413B. End portions of the submicron-sized fibers extend out from the larger fiber stem 413B and form the branches of the tree, comprising the number of small fibers 413A.

FIG. 4C shows needle-like structures 423 used to form the substrate 400. The process, mechanisms, and design principles for capturing particles without bounce is similar to that of the fiber 403 structured discussed with reference to FIG. 4A. The needle-like structures 423 may be formed from a rigid or semi-rigid material with a base diameter on the order of microns down to sub-microns to capture particles similar in size to the base diameter of the needle-like structures 423. The base 401 of the substrate 400 can be a rigid material, a soft material, or any of the other materials discussed above. In a specific embodiment, the needle-like structures 423 may be formed and pierced through the base 401. The needle-like structures 423 may also be fabricated using various etching and milling processes and techniques commonly used in the semiconductor, micro-electronic mechanical systems (MEMS), and allied industries.

An enlarged section 450 of one of the needle-like structures 423 indicates an angle, θ₁, of the needle-like structure 423 from vertical (i.e., normal to the base 401). The angle may have an affect on particle sizes captured. For example, as the angle from vertical increases, the needle-like structures 423 will have a tendency to more gently slow the velocity of the incoming particles. The angle also forces the particles to bounce “downward” toward the base 401 at some acute angle, thereby reducing the kinetic energy of the particle. Similar to Snell's Law in optics, the angle of particle incidence with the needle-like structure 423 is similar to angle of particle of particle reflection away from the needle-like structure 423. Therefore, an increased angle tends to reflect the particles farther from the needle-like structure 423. However, the increased angle may also reduce the loading capacity of the substrate 400 since there will either be less room between adjacent ones of the needle-like structures 423 or the density of the needle-like structures 423 per unit of area on the based will be reduced.

One factor to consider in determining the angle may be related to the environment in which the substrate is used and an aerial density of particles present in the environment. For example, a clean room in the semiconductor industry may have a maximum number of particle greater than or equal to 0.1 μm of no more than 10 particle per cubic meter according to the ISO 1 standard. In this environment, particle loading is far less of an issue than in a high particle-density environment. In contrast, a room rated at ISO 9 (similar to an office environment) may have no more than approximately 35 million particles per cubic meter that are greater than or equal to 0.5 μm.

In FIG. 4D, the substrate 400 has blade-like structures 433 mounted to the base 401. The process, mechanisms, and design principles for capturing particles without bounce is similar to that of the fiber 403 structured discussed with reference to FIG. 4A. The blade-like structures 433 may be formed from a variety of rigid or semi-rigid materials, similar to those discussed above with reference to the needle-like structures 423 of FIG. 4C. A base dimension of the blade-like structures 433 may be on the order of microns down to sub-microns to capture particles similar in size to the base dimension of the blade-like structures 433. The base 401 of the substrate 400 can be a rigid material, a soft material, or any of the other materials discussed above.

As with the needle-like structure 423 design, an angle, θ₂, of the blade-like structure 433 as indicated in an enlarged portion 470 of FIG. 4D, impinging particles bounce downward toward the base 401 at an angle similar to the angle of the blade-like structure 433 (since the incoming particle-laden air flow is substantially normal to the base 401). In addition, the closeness of the spacing between blades allows particles to penetrate but minimizes air turbulence generated inside the blade-like structure 433. Also as indicated in the enlarged portion, the blade-like structure 433 may be internally hollow but may also be solid. The blade-like structures 433 may also be fabricated using various etching and milling processes and techniques commonly used in the semiconductor, micro-electronic mechanical systems (MEMS), and allied industries.

FIGS. 5A through 5F show various types of channel and substrate combinations for capturing and retaining particles. The various channel and substrate combinations may be used with any of the particle-impaction devices discussed herein.

Referring now to FIG. 5A, the channel 305 contains a substrate 325 formed within the channel 305 and over a cavity 317A. As used throughout, the cavity 317A, and other cavities discussed, may also be non-existent (the substrate 325 or other substrates are formed at or down to the base of the channel 305. Although FIG. 5A indicates the substrate 325 is placed in an upper portion of the channel 305, the substrate 325 may be placed anywhere within the channel 305 as discussed below. In a case where the substrate 325 is selected to be a porous or semiconductor-porous material, the substrate 325 may be formed near the top of the channel 305. The placement near or at the top of the channel 305 allows the incoming airstream to penetrate into the cavity 317A, improving the capture and holding capacity of particles. The cavity 317A can be formed in the channel 305 with channel 305 having sealed or partially sealed ends (e.g., each end of an elongated channel). The sealed partially sealed ends of the channel 305 may comprise a high-efficiency filtration material. In this case, the cavity 317A may be considered to be a virtual impactor.

The substrate 325 may be selected from any one or a combination of the various substrates described herein including, for example, the substrates 400 of FIG. 4A through FIG. 4D. The cavity 317A is generally an airspace but may also comprise other gases or materials. In a specific embodiment, the cavity 317A may be another substrate. A volume of the cavity 317A may be chosen based on a variety of factors. For example, the factors may include whether there is water or other liquid present in the incoming airstream. The liquid may be in the form of vapor in the airstream or one or more layers of water on particles in the airstream. The volume of the cavity 317A may be selected, in part, depending on whether any collected liquid needs to be drained from the channel. Drainage of liquid from the particle-laden air is discussed in more detail with reference to FIG. 6B, below.

In FIGS. 5B and 5C, respectively, an upward-curved substrate 331 (i.e., concave with reference to a side distal from a cavity 317B or convex with reference to a side proximal to the cavity 317B) and a downward-curved substrate 341 (i.e., convex with reference to a side distal from a cavity 317C) are shown. As indicated by an enlarged portion 510 of FIG. 5B, the upward-curved substrate 331 has an upward slope angle, θ₃. As indicated by an enlarged portion 520 of FIG. 5C, the downward-curved substrate 341 has an downward slope angle, θ₄. The slopes of the respective substrates 331, 341 may be selected based on factors discussed above with reference to FIGS. 4C and 4D coupled with knowledge of what types of particles and particle sizes are expected to be encountered. The factors can also include, for example, the relative coefficient of restitution ratios between the particle type and the substrate 331, 341, as well as general characteristics of the particle including morphology of the particle. These and other factors, including an application of the Stokes equation, may be considered in determining the slope angles θ₃ and θ₄ and a resultant difference in particle collection efficiency.

FIGS. 5D through 5F have similarities to the FIGS. 5A through 5C, respectively. However, each of the channels 305 in FIGS. 5D through 5F have a particle trap 353 placed on top of the channels 305 (and partially covering the substrates 325, 331, 341). The particle trap 353 may be a solid, porous, or semi-porous material (as described herein) with an opening or aperture having a width, W₄. The opening or aperture may be round, elliptical, polygonal, or other shape. However, a round opening has a greater particle collection efficiency than a slit or other rectangular shape. The width, W₄, may be determined from the size of the nozzle width W₂. In a specific embodiment, the opening or aperture of the particle trap 353 is a rectangular slot and has a dimension, W₄, of about 1.5 times to about 3 times that of W₂.

With continuing reference to FIGS. 5D through 5F, particle-laden air that is accelerated by an impaction nozzle (e.g., the impaction nozzle 315 of FIG. 3A) placed over the particle trap 353 impacts onto the substrate 325, 331, 341 through the opening or aperture of the particle trap 353. Relative spacing regions 355, 365, 375 between the particle trap 353 and the respective substrates 325, 331, 341 can be determined, based on various factors disclosed herein, to trap some fraction of particles that may have otherwise bounced from the substrate 325, 331, 341. As particles bounce from the substrate 325, 331, 341, they hit the lower surface of the particle trap 353. Depending upon the angle of the bounce, the particles may be reflected back to the substrate 325, 331, 341. The relative spacing regions 355, 365, 375 between the particle trap 353 and the respective one of the substrates 325, 331, 341 may be designed to reduce or eliminate air turbulence in the relative spacing regions 355, 365, 375 so some fraction of the particles can be captured and not be re-entrained into the air stream. Determination of minimizing or reducing air turbulence is known independently in the art of fluid mechanics.

With reference now to FIG. 6A, a multi-stage inertial impactor 600 utilizing multiple stages of the particle-impaction devices of FIG. 3A and FIG. 3B is shown. The multi-stage inertial impactor 600 of the embodiment of FIG. 6A has a first-level impaction stage 610, a second-level impaction stage 620, and a third-level impaction stage 630. However, based upon a reading an understanding of the disclosure provided herein, a person of ordinary skill in the art will recognize that more or fewer than three stages may be used.

Each of the three stages of the multi-stage inertial impactor 600 has an associated impaction nozzle. For example, a space between the channels 305 in the first-level impaction stage 610 forms a first impaction nozzle 621 for the second-level impaction stage 620. A space between the channels 305 in the second-level impaction stage 620 forms a second impaction nozzle 623 for the third-level impaction stage 630. A space between the channels 305 in the third-level impaction stage 630 forms a third impaction nozzle 625 for subsequent impaction stages (not shown).

To collect decreasingly smaller sizes of particle at each stage of the multi-stage inertial impactor 600, the velocity of the airstream passing through subsequent levels of impaction nozzles (e.g., from the first-level impaction stage 610 to the second-level impaction stage 620) is increased. As indicated by the Stokes equation, decreasingly smaller particles may be impacted and collected by subjecting the particle-laden airstream to an increasingly higher velocity. Therefore, by designing the width, W₆, of the first impaction nozzle 621 to be greater than the width, W₇, of the second impaction nozzle 623, the velocity of particles into the second-level impaction stage 620 is less than the velocity of particles into the third-level impaction stage 630. Consequently, due to the higher velocity of particles into the third-level impaction stage 630, the collected particles are smaller than those collected at the second-level impaction stage 620. Similarly, by designing the width, W₇, of the second impaction nozzle 623 to be greater than the width, W₈, of the third impaction nozzle 625, the velocity of particles into the third-level impaction stage 630 is less than the velocity of particles into subsequent levels of impaction stage. Consequently, due to the higher velocity of particles into the subsequent levels, the collected particles are smaller than those collected at the third-level impaction stage 630. Thus, the multi-stage inertial impactor 600 collects large particles at the first-level impaction stage 610. Then, the next smaller-sized particles are collected by the second-level impaction stage 620. Finally, the smallest-sized particles are collected by the third-level impaction stage 630.

A distance, H₅, between the first-level impaction stage 610 to the second-level impaction stage 620 may be determined by applying the Stokes equation depending upon a particle size range to be captured at each level. A distance, H₅, between the second-level impaction stage 620 to the third-level impaction stage 630 may be similarly determined by applying the Stokes equation depending upon a particle size range to be captured at these levels.

Since different sizes of particles are collected at different stages, each of the substrates may be chosen to be of differing materials, porosity, or thicknesses than subsequent stages. For example, a first substrate material 307A in the first-level impaction stage 610 may be selected to have a larger open-area or comprising a softer material than a second substrate material 307B in the second-level impaction stage 620. The larger open area may allow more liquid in the airstream to be released at the first-level impaction stage 610. Also, the softer material may prevent the larger particles, having higher inertia than the smaller particles, from bouncing and becoming re-entrained into the airstream. Similarly, the second substrate material 307B may be selected to have a larger open-area or comprising a softer material than a third substrate material 307C in the third-level impaction stage 630. Based on the disclosure provided herein, a person of ordinary skill in the art may readily determine which material or materials are appropriate for a given level of the impaction stages.

FIG. 6B shows illustrative example details of an air/liquid separator 650 coupled to the multi-stage inertial impactor 600 of FIG. 6A. In an embodiment, a drain C-channel 601 may be formed behind an impactor support structure 603. The impactor support structure 603 comprises a number of liquid collection-plates 605 to provide a liquid drain path from each of the channels 305 (a hole in each channel, not shown, may be located at an end of the channel 305 closest to the impactor support structure 603). Additionally, additional holes in a portion of the impactor support structure 603 closest to the drain C-channel 601 allow the collected liquid to flow from the impactor support structure 603 to the drain C-channel 601. A hole 651 in the drain C-channel 601 may be coupled to a system drain path to remove collected water from the air-liquid separator 650. The hole 651, can be elliptical, polygonal, or any other shape and need not be round as shown.

In a specific embodiment, the drain C-channel 601 may have a height, H₇, of approximately 44.5 mm (1.75 inches). The diameter, D₁, of the hole 651 is approximately 25.4 mm (1.0 inches). The impactor support structure 603 may be sized similarly to the drain C-channel 601 and each may be formed from materials including, for example, aluminum, various plastics, various ceramics, or various other materials. The liquid collection-plates 605 may be formed from a U-channel or C-channel having a height, Hg, of approximately 3.18 mm (0.125 inches) and a width, W₁₀, of approximately 19.1 mm (0.75 inches). The channels 305 may be formed from any of the materials used to produce the other components of the air/liquid separator 650 (e.g., aluminum, plastics, or ceramics) and have a height, H₉, of approximately 12.7 mm (0.50 inches) and a width, W₁₁ of approximately 15.9 mm (0.625 inches). A thickness, th₁, of the channels 305 may be approximately 1.59 mm (0.0625 inches).

Referring now to FIG. 7A and FIG. 7B, graphs of particle fractional efficiency as a function of particle diameter for various ones of the devices, substrates, apparatuses, and combinations thereof as discussed with reference to FIG. 3A through FIG. 6B are shown. To produce the graphs, data were collected from an experimental test involving providing challenge particles of potassium chloride (KCl, a metal-halide salt) to a particle-impaction device (e.g., the particle-impaction device 300 of FIG. 3A) at a volumetric flow rate of approximately 56.6 cubic meters per minute (2000 cfm). The challenge particles were produced in monodispersed sizes from approximately less than 0.3 μm to approximately greater that 10 μm by an aerosol generator, known independently in the art, and input to the particle-impaction device. The particle concentrations (number per unit volume) were measured both upstream and downstream of the particle-impaction device. By comparing the measured concentrations of particles, a fractional efficiency of particle collection was determined by equation (2);

$$Fractional Efficiency [ \% ] = \frac{{c}_{u} - {c}_{d}}{{c}_{u}} \times 100 \qquad ( 2 )$$

where Cᵤ is the particle concentration of particles measured upstream of the particle-impaction device and C_{d} is the particle concentration of particles measured downstream of the particle-impaction device.

With specific reference to the impactor test filter graph 700 of FIG. 7A, a first curve 701 indicates the fractional efficiency as a function of particle diameter in the particle-impaction device using velvet as the substrate material covering a flat impaction-plate (e.g., the flat impaction-plate 323 of FIG. 3B). A second curve 703 indicates the fractional efficiency as a function of particle diameter in the particle-impaction device using only the flat impaction-plate. As indicated by the impactor test filter graph 700, using the velvet substrate significantly improved the fractional efficiency, especially at larger particle sizes.

Referring now to the impactor test filter graph 710 of FIG. 7B, a first curve 705 indicates the fractional efficiency as a function of particle diameter in the particle-impaction device using velvet as the substrate material covering a channel (e.g., the channel 305 of FIG. 3A) with the cavity 317. A second curve 707 indicates the fractional efficiency as a function of particle diameter in the particle-impaction device using velvet as the substrate material without the cavity 317. As indicated by the impactor test filter graph 710, the using the velvet substrate significantly improved the fractional efficiency, especially at larger particle sizes. Comparing the test filter graphs of FIG. 7A and FIG. 7B, there is a significantly greater collection fractional efficiency with the velvet substrate over the channel of the first curve 705 (peaking at about 95%) than the velvet substrate on the flat impaction-plate as indicated by the first curve 701 (peaking at about 83%).

Thus, in various embodiments, a device is provided that includes an inlet air passage to direct a particle-laden airstream, an outlet air passage, an impaction nozzle in fluid communication with and downstream of the inlet air passage, and a channel in fluid communication with and downstream of the impaction nozzle and upstream of the outlet air passage. An open portion of the channel is oriented substantially toward the inlet air passage and has a cavity at least partially covered with a substrate material. A base of the substrate material is substantially normal to an incoming direction of the particle-laden airstream.

In some embodiments of the device, an open portion of the channel is substantially oriented toward the inlet air passage and is covered with a particle trap. The particle trap has an opening to allow at least a portion of the particle-laden air to enter the channel.

In various embodiments, a particle-capture device is provided that includes an inlet fluid passage and an outlet fluid passage to pass particle-laden air. At least one level of a number of elongate channels is located between and in fluid communication with the inlet fluid passage and the outlet fluid passage. Each of the elongate channels is arranged such that channels each have a long axis being substantially perpendicular to a direction of fluid flowing from the inlet fluid passage to the outlet fluid passage. The elongate channels have an open portion of the channel arranged substantially toward the inlet fluid passage and at least partially covered with a substrate material. The base of the substrate material is substantially aligned with a flow direction of the particle-laden air as it exits the impaction nozzle.

In some embodiments of the device, each level of the elongate channels have an impaction nozzle placed on an upstream side of each respective level of the channels. The impaction nozzle of each respective level has decreasingly smaller openings than an adjacent one of the impaction nozzles located upstream. The decreasingly smaller openings are to increase the velocity of the particle-laden air.

In various embodiments, a method of capturing particles from particle-laden air is provided. The method includes directing the particle-laden air to an inlet fluid passage, selecting a substrate material to reduce bouncing of the particles; and placing the substrate material in a channel downstream of the impaction nozzle.

In some embodiments of the method, the substrate material is selected to be comprised of a material selected from at least one of the following groups including: velvet, foam, and a porous material. In some embodiments of the method, the substrate material is selected to have a structure from at least one of the following groups including: fibers, tree-like structures, needle-like structures, and blade-like structures. Each of the structures is arranged substantially vertically relative to a base of the substrate material.

A person of ordinary skill in the art will appreciate that, for this and other methods and apparatuses disclosed herein, the activities forming part of various methods may be implemented in a differing order, as well as repeated, executed simultaneously, or substituted one for another. Further, the outlined acts and operations are only provided as examples, and some of the acts and operations may be optional, combined into fewer acts and operations, or expanded into additional acts and operations without detracting from the essence of the disclosed embodiments.

The present disclosure should not be construed to be limited in terms of the particular embodiments described in this application, which are intended as illustrations of various aspects of the apparatuses. Many modifications and variations can be made, as will be apparent to a person of ordinary skill in the art upon reading and understanding the disclosure. Functionally equivalent methods and apparatuses within the scope of the disclosure, in addition to those enumerated herein, will be apparent to a person of ordinary skill in the art from the foregoing descriptions. Portions and features of some embodiments may be included in, or substituted for, those of others. Many other embodiments will be apparent to those of ordinary skill in the art upon reading and understanding the description provided herein. Such modifications and variations are intended to fall within a scope of the appended claims. The present disclosure is to be limited only by the terms of the appended claims, along with the full scope of equivalents to which such claims are entitled. It is also to be understood that the terminology used herein is for the purpose of describing particular embodiments only and is not intended to be limiting.

Moreover, the description provided herein includes illustrative apparatuses (e.g., devices, structures, systems, and the like) and methods (e.g., processes, sequences, techniques, and technologies) that embody various aspects of the subject matter. In the detailed description, for purposes of explanation, numerous specific details are set forth in order to provide an understanding of various embodiments of the subject matter. It will be evident, however, to those skilled in the art that various embodiments of the subject matter may be practiced without these specific details. Further, well-known apparatuses and methods have not been shown in detail so as not to obscure the description of various embodiments. Additionally, as used herein, the term “or” may be construed in either an inclusive or exclusive sense.

The Abstract of the Disclosure is submitted with the understanding that it will not be used to interpret or limit the claims. In addition, in the foregoing Detailed Description, it may be seen that various features are grouped together in a single embodiment for the purpose of streamlining the disclosure. This method of disclosure is not to be interpreted as limiting the claims. Thus, the following claims are hereby incorporated into the Detailed Description, with each claim standing on its own as a separate embodiment.

What is claimed is:

1. A particle-capture device, comprising:
an inlet air passage to direct a particle-laden airstream;
an outlet air passage;
an impaction nozzle in fluid communication with and configured to be downstream of the inlet air passage; and
a channel in fluid communication with and configured to be downstream of the impaction nozzle and upstream of the outlet air passage, an open portion of the channel being substantially oriented toward the inlet air passage and having a cavity at least partially covered with a substrate material, a base of the substrate material being substantially normal to an incoming direction of the particle-laden airstream.

2. The particle-capture device of claim 1, wherein an opening of the impaction nozzle has a cross-sectional area that is smaller than a cross-sectional area of an opening of the inlet air passage to increase a velocity of the particle-laden airstream toward the channel.

3. The particle-capture device of claim 1, wherein the cavity is contained within at least a portion of the channel.

4. The particle-capture device of claim 3, wherein an the channel that is substantially oriented toward the inlet air passage is covered with a particle trap, the particle trap having an opening to allow at least a portion of the particle-laden air to enter the channel.

5. The particle-capture device of claim 1, wherein the substrate material has fibers arranged substantially vertically relative to a base of the substrate material.

6. The particle-capture device of claim 1, wherein the substrate material has a number of tree-like structures arranged substantially vertically relative to a base of the substrate material.

7. The particle-capture device of claim 6, wherein the tree-like structures each have small branch-like fibers surrounding a larger fiber stem.

8. The particle-capture device of claim 1, wherein the substrate material has a number of needle-like structures arranged substantially vertically relative to a base of the substrate material.

9. The particle-capture device of claim 1, wherein the substrate material has a number of blade-like structures arranged substantially vertically relative to a base of the substrate material.

10. The particle-capture device of claim 1, wherein the substrate material comprises a velvet material.

11. The particle-capture device of claim 1, wherein the substrate material comprises a felt material.

12. The particle-capture device of claim 1, wherein the substrate material comprises a foam material.

13. The particle-capture device of claim 1, wherein the substrate material comprises a porous material.

14. The particle-capture device of claim 1, wherein the substrate material is concave with reference to a distal side of the cavity.

15. The particle-capture device of claim 1, wherein the substrate material is convex with reference to a distal side of the cavity.

16. A particle-capture device, the device comprising:
an inlet fluid passage and an outlet fluid passage to pass particle-laden air; and
at least one level of a plurality of elongate channels located between and in fluid communication with the inlet fluid passage and the outlet fluid passage, each of the plurality of elongate channels arranged such that the plurality of elongate channels has a long axis being substantially perpendicular to a direction of fluid flowing from the inlet fluid passage to the outlet fluid passage, the plurality of elongate channels having an open portion of the channel arranged substantially toward the inlet fluid passage and at least partially covered with a substrate material, the substrate material being substantially aligned with a flow direction of the particle-laden air.

17. The particle-capture device of claim 16, wherein the at least one level of a plurality of elongate channels each have a hole.

18. The particle-capture device of claim 16, wherein the at least one level of a plurality of elongate channels each have an impaction nozzle placed on an upstream side of each level of elongate channels, the impaction nozzle of each respective level having decreasingly smaller openings than an adjacent one of the impaction nozzles located upstream, the decreasingly smaller openings to increase velocity of the particle-laden air.

19. A method of capturing particles from particle-laden air, the method comprising:
directing the particle-laden air to an inlet fluid passage;
selecting a substrate material to reduce bouncing of the particles; and
placing the substrate material in a channel downstream of the impaction nozzle.

20. The method of claim 19, wherein selecting the substrate material includes selecting the material from at least one of the following groups, the groups including velvet, foam, a porous material, and a semiconductor-porous material.

21. The method of claim 19, further comprising selecting the substrate material to be comprised of a material having a structure selected from at least one of the following groups, the groups including fibers, tree-like structures, needle-like structures, and blade-like structures, wherein each of the structures is arranged substantially vertically relative to a base of the substrate material.
